(19) United States
(12) Patent Application Publication
(10) Pub. No.: US 2022/0302775 A1
(43) Pub. Date: Sep. 22, 2022

(54) STATOR CORE AND COOLING METHOD THEREOF

(71) Applicant: FORD GLOBAL TECHNOLOGIES, LLC, Dearborn, MI (US)

(72) Inventors: Chuan DENG, Nanjing (CN); Guohua DU, Nanjing (CN); Yigang YUAN, Nanjing (CN)

(73) Assignee: FORD GLOBAL TECHNOLOGIES, LLC, Dearborn, MI (US)

(21) Appl. No.: 17/690,454

(22) Filed: Mar. 9, 2022

(30) Foreign Application Priority Data
Mar. 17, 2021 (CN) 2021102869948

(51) Int. Cl. H02K 1/20; H02K 9/19; H02K 5/20; B60K 6/26

(52) U.S. Cl. CPC H02K 1/20; H02K 9/19; H02K 5/20; B60K 6/26

(57) ABSTRACT

A stator core of an electric machine is formed by a plurality of laminations stacked in an axial direction with each lamination having a plurality of teeth extending toward the inner circumference in a radial direction forming a plurality of slots between adjacent teeth. The plurality of teeth of each lamination include first teeth with a first radial length and at least one second tooth with a second radial length. The second teeth of the plurality of laminations are arranged in the axial direction to form a fluid passage between first and second ends of the stator core.

### CROSS-REFERENCE TO RELATED APPLICATIONS

This application claims foreign priority benefits under 35 U.S.C. § 119(a)-(d) to CN Application 2021 102 869 948 filed Mar. 17, 2021, which is hereby incorporated by reference in its entirety.

### TECHNICAL FIELD

The present disclosure relates to a stator core of an electric machine and a cooling method for the stator core of the electric machine for a vehicle.

### BACKGROUND

Electric vehicles are developing rapidly in the design and manufacture of modern vehicles. Vehicles such as pure electric vehicles (BEVs), plug-in electric vehicle (PHEVs), and hybrid electric vehicles (HEVs) include electric machines that drive wheels.

Through the cooperation of a stator and a rotor, the electric machine converts electrical energy into mechanical motion, or converts mechanical motion into electrical energy. As the power source of BEV, PHEV and HEV, the electric machine will generate heat in its stator elements when it is rotating by being energized, especially in the winding coil and the stator core. If the heat cannot be removed expeditiously, it may cause the power and efficiency of the electric machine to decrease, and in severe cases, the service life of the electric machine may be affected.

The Chinese patent application with an application number of 201922116531.8 and titled of “Liquid-cooled Stator Iron Core And Electric Machine” provides a cooling device for the stator core. The cooling device cools the outside of the stator iron core or back iron by arranging cooling passages in the outer wall of the stator iron core, and the cooling demand inside the stator iron core is not considered.

Under the above background, the inventors realized that an improved electric machine cooling structure and method is needed to achieve efficient cooling of the inner circumference of the electric machine stator to improve the power and efficiency of the electric machine operation.

### SUMMARY

An advantage of various configurations described in the present disclosure is that they provide an electric machine stator with cooling passages and a method of cooling the inner circumference of the stator using cooling passages.

According to the present disclosure, a stator core of an electric machine is provided. A plurality of laminations is stacked in an axial direction to form the stator core having an inner circumference and an outer circumference. Each lamination has a plurality of teeth extending toward the inner circumference in a radial direction and a plurality of slots each formed between adjacent ones of the plurality of teeth. The plurality of teeth of each lamination include first teeth with a first radial length and at least one second tooth with a second radial length. The second teeth of the plurality of laminations are arranged in the axial direction to form a fluid passage between first and second ends of the stator core. The second radial length may be smaller than the first radial length. At least some of the plurality of slots may be closed slots without an opening toward the inner circumference. At least some of the plurality of slots may be open slots with an opening toward the inner circumference. The stator core may have an inner wall member that is a hollow cylinder and is configured to adjoin the inner circumference of the stator core to close the opening.

In one or more embodiments, the second teeth of the plurality of laminations are aligned along the axial direction to form the fluid passage paralleled to a central axis of the stator core, and the fluid passage is linear. The second teeth of the plurality of laminations may be at least partially staggered along the axial direction to form the fluid passage at least partially surrounding an inner peripheral surface of the stator core. The plurality of laminations may include a first set of laminations and a second set of laminations. The first set of laminations align the second teeth thereof along the axial direction to form a first stator segment having a first flow passage segment, and the second set of laminations align the second teeth thereof along the axial direction to form a second stator segment having a second flow passage segment. The first and second stator segments are stacked so that the first and second flow passage segments are fluidly connected and at least partially staggered to form the fluid passage around an inner peripheral surface of the stator core.

In various embodiments, the plurality of teeth of each lamination include at least a second tooth in a first position and a second tooth in a second position. A plurality of second teeth in the first position are at least partially aligned along the axial direction to form a first fluid passage, and a plurality of second teeth in the second position are at least partially aligned along the axial direction to form a second fluid passage. The second tooth in the first position is different from the second tooth in the second position. The first and the second fluid passages may be parallel to a central axis of the stator core.

In one or more embodiments, the plurality of laminations align the second teeth in the first position thereof along the axial direction to form a stator segment having a first flow passage. The stator segment at least includes a first stator segment and a second stator segment. The first and second stator segments are stacked so that the first flow passages are fluid connected and spirally surround an inner peripheral surface of the stator core to form the first fluid passage. And the plurality of laminations align the second teeth in the second position thereof along the axial direction to form a stator segment having a second flow passage. The stator segment at least includes a first stator segment and a second stator segment. The first and second stator segments are stacked so that the second flow passages are fluid connected and spirally surround the inner peripheral surface of the stator core to form the second fluid passage.

Embodiments may also include an electric machine having a stator surrounding a rotor with an air gap therebetween. The stator includes a stator core having an inner circumference and an outer circumference formed by stacking a plurality of laminations in an axial direction. Each lamination has a plurality of teeth extending toward the inner circumference in a radial direction and a plurality of slots each formed between adjacent ones of the plurality of teeth. The plurality of teeth of each lamination include first teeth with a first radial length and at least one second tooth with a second radial length. The second teeth of the plurality of laminations are arranged in the axial direction to form a fluid passage between first and second ends of the stator core. The second radial length may be smaller than the first radial length. At least some of the plurality of slots may be closed slots without an opening toward the inner circumference. Similarly, at least some of the plurality of slot may be open slots with an opening toward the inner circumference. The stator core may include an inner wall member that is a hollow cylinder and is configured to adjoin the inner circumference of the stator core to close the opening.

In one or more embodiments, the plurality of laminations comprises a first set of laminations and a second set of laminations. The first set of laminations align the second teeth thereof along the axial direction to form a first stator segment having a first flow passage segment, and the second set of laminations align the second teeth thereof along the axial direction to form a second stator segment having a second flow passage segment. The first and second stator segments are stacked so that the first and second flow passage segments are fluidly connected and at least partially staggered to form the fluid passage around an inner peripheral surface of the stator core. The plurality of teeth of each lamination may include at least a second tooth in a first position and a second tooth in a second position. A plurality of second teeth in the first position are at least partially aligned along the axial direction to form a first fluid passage, and a plurality of second teeth in the second position are at least partially aligned along the axial direction to form a second fluid passage. The second tooth in the first position is different from the second tooth in the second position. The first and the second fluid passages may be parallel to a central axis of the stator core. The plurality of laminations may align the second teeth in the first position thereof along the axial direction to form a stator segment having a first flow passage. The stator segment at least includes s first stator segment and a second stator segment. The first and second stator segments are stacked so that the first flow passages are fluidly connected and spirally surround an inner peripheral surface of the stator core to form the first fluid passage. The plurality of laminations may align the second teeth in the second position thereof along the axial direction to form a stator segment having a second flow passage. The stator segment at least includes a first stator segment and a second stator segment. The first and second stator segments are stacked so that the second flow passages are fluidly connected and spirally surround the inner peripheral surface of the stator core to form the first fluid passage.

Embodiments may also include a cooling method for a stator core that includes flowing a cooling fluid through a fluid passage in an axial direction between first and second ends of the stator core, and stacking a plurality of laminations in the axial direction to form the stator core having an inner circumference and an outer circumference, wherein each lamination has a plurality of teeth extending toward the inner circumference in a radial direction and a plurality of slots formed between the plurality of teeth, wherein the plurality of teeth of each lamination include first teeth with a first radial length and at least one second tooth with a second radial length, and the second teeth of the plurality of laminations are arranged in the axial direction to form a fluid passage between the first and second ends of the stator core. The second teeth of the plurality of laminations may be at least partially staggered along the axial direction to form the fluid passage at least partially spirally surrounding an inner peripheral surface of the stator core.

For a better understanding of the present disclosure, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further in the figures, like referenced numerals refer to like parts throughout the different figures.

### BRIEF DESCRIPTION OF THE DRAWINGS

FIG. 1 shows a schematic diagram of a stator lamination of a stator core of an electric machine.

FIG. 1A shows an enlarged schematic view of part A of the stator lamination of the stator core of the electric machine in FIG. 1.

FIG. 1B shows a schematic diagram of a closed tooth of the stator lamination of the stator core of the electric machine according to one or more embodiments.

FIG. 2 shows a schematic diagram of an electric machine stator according to one or more.

FIG. 2A shows a schematic diagram of fluid passages of the electric machine stator according to one or more embodiments.

FIG. 2B shows a schematic diagram of fluid passages of the electric machine stator according to one or more embodiments.

FIG. 3 shows a schematic diagram of a stator lamination of a stator core of an electric machine according to one or more embodiments

FIG. 4 shows a schematic diagram of an electric machine stator according to one or more embodiments.

FIG. 5 shows a schematic diagram of an inner wall member of the electric machine stator according to one or more embodiments.

FIG. 6 shows a schematic diagram of an electric machine stator according to one or more embodiments.

### DETAILED DESCRIPTION

The embodiments of the present disclosure are described below. However, it should be understood that the disclosed embodiments are merely examples, and other embodiments may take various alternative forms. The drawings are not necessarily drawn to scale; some functions may be exaggerated or minimized to show details of specific components. Therefore, the specific structural and functional details disclosed herein should not be construed as restrictive, but merely serve as a representative basis for teaching those skilled in the art to use the present disclosure in various ways. As those of ordinary skill in the art will understand, the various features shown and described with reference to any one drawing can be combined with the features shown in one or more other drawings to produce embodiments that are not explicitly shown or described. The combinations of features shown provide representative embodiments for typical applications. However, various combinations and modifications to features consistent with the teachings of the present disclosure may be desirable for certain specific applications or implementations.

As mentioned in the background, the electric machine will generate heat in its stator elements when it is rotating by being energized, especially in the winding coil and the stator core. If the heat cannot be efficiently removed, it may cause the power and efficiency of the electric machine to decrease, and the service life of the electric machine may be affected. The inventors realized that an improved electric machine cooling structure and method is needed to achieve efficient cooling of the inner circumference of the motor stator to improve the power and efficiency of the electric machine operation.

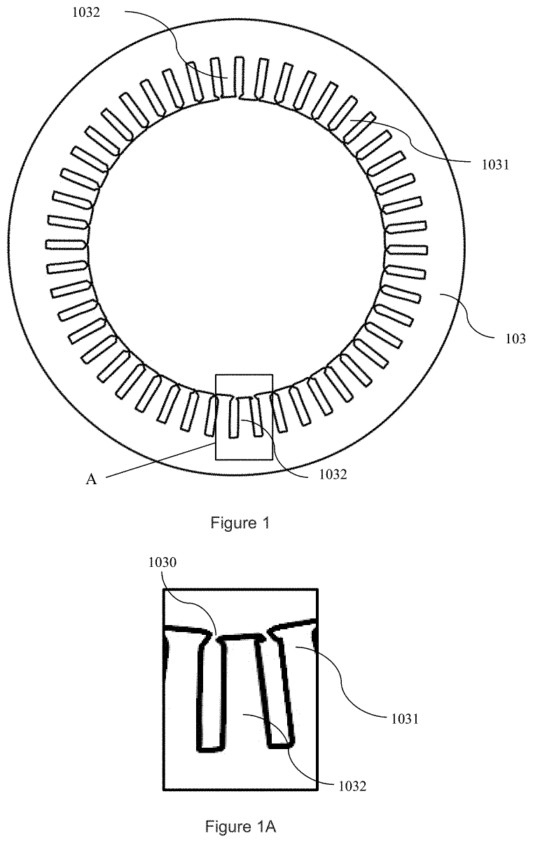

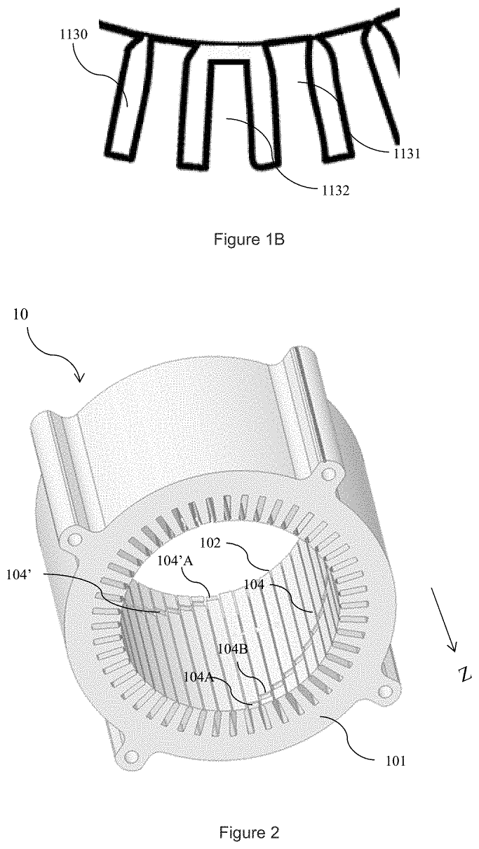

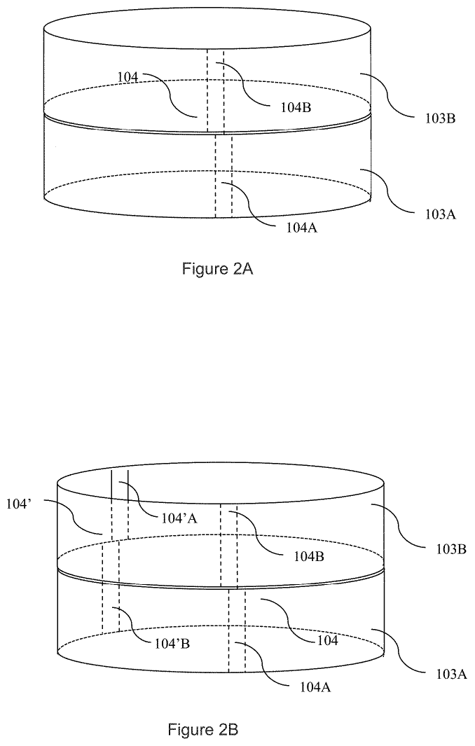

In the embodiment of the disclosure shown in FIGS. 1 and 2, a stator core 10 is composed of a plurality of stator laminations 103 stacked along an axial direction Z. And thus, a first end 101 and a second end 102 of the stator core 10 are formed, wherein the second end 102 is opposite to the first end 101 in the Z direction.

As shown in FIGS. 1, 1A and 1B, the stator lamination 103 has a plurality of teeth extending inwardly in a radial direction. The plurality of teeth include first teeth 1031 with a first radial length and second teeth 1032 with a second radial length, wherein the first radial length is larger than the second radial length. The plurality of teeth extend in the radial direction to form a plurality of slots extending from the inner circumference toward the outer circumference of the stator laminations 103. In this embodiment, the plurality of slots are open slots 1030 with an opening toward the inner circumference. It can be understood that, as shown in FIG. 1B, the closed slots 1130 without an opening toward the inner circumference also belong to the protection scope of the present disclosure. In this embodiment, the slots formed by the plurality of first teeth 1131 are the closed slots 1130 without an opening toward the inner circumference, and the first teeth 1131 are longer than the second teeth 1132 in the radial direction. Also in this embodiment, the stator laminations 103 have two second teeth 1032 oppositely arranged. It is understood that the arrangement of one or more second teeth 1032 also belong to the protection scope of the present disclosure.

When a plurality of stator laminations 103 are stacked to form the stator core 10, the stator laminations 103 align their second tooth 1032 in the axial direction Z to form a fluid passage 104 on the inner peripheral region of the stator core 10. The fluid passage 104 may extend from the first end 101 to the second end 102.

As shown in FIG. 2A, in one embodiment of the present disclosure, one set of the stator laminations 103 align the second teeth 1032 thereof in the axial direction Z to form a first stator segment 103A having a first flow passage segment 104A, and another set of the stator laminations 103 align the second teeth 1032 thereof in the axial direction Z to form a second stator segment 103B having a second flow passage segment 104B. In the embodiment shown in FIG. 2A, the first stator segment 103A and the second stator segment 103B are stacked so that the first flow passage segment 104A and the adjacent second flow passage segment 104B are at least partially staggered both in the inner circumference direction and in the axis direction, to form a curvilinear fluid passage 104 on the surface surrounding the inner peripheral region of the stator core 10. It is to be understood that the term “surrounding” as used herein includes fluid passages of various shapes such as zigzag, curvilinear, helical, etc., extending on the surface of the inner peripheral region between the first end 101 and the second end 102 of the stator core 10. The fluid passage can extend in any range of central angle on the surface of the inner peripheral area, for example, central angles of 30 degrees, 90 degrees, 180 degrees, or 360 degrees that surrounds and covers the entire surface of the inner peripheral area. It will also be understood by those skilled in the art that the term “ curvilinear ” should not be considered limiting, but merely an illustrative embodiment. Although in the described embodiments, the above-described fluid passages 104 are generally curvilinear or helical around the inner peripheral surface, it can also be seen that the above-mentioned fluid passage 104 also presents a sawtooth or stepped shape. In addition, those skilled in the art can also understand that the first fluid passage 104 formed by the first flow passage segment 104A of the first stator segment 103A and the second flow passage segment 104B of the second stator segment 103B shown in FIG. 2A are only example. Wherein each set of stator segment may be formed by stacking a different number of stator laminations 103, and the fluid passage 104 may be formed by two or more sets of stator segments in the stacked manner as shown in FIG. 2A.

In another embodiment, when a plurality of stator laminations 103 with closed slots 1130 are stacked to form the stator core 10, the second teeth 1132 without openings of each stator lamination 103 are arranged in the axial direction Z to form the fluid passages on the inner peripheral area of the stator core 10. Different from the fluid passages formed by the laminations with open slots, the fluid passages formed by the second teeth 1132 of the laminations with closed slots 1130 are closed passages, which effectively avoid fluid spillage.

In the embodiment shown in FIG. 2, two fluid passages spaced apart from each other are provided. When a plurality of stator laminations 103 are stacked to form the stator core 10, the stator laminations 103 align two second teeth 1032 at different positions thereof in the axial direction Z to form two fluid passages on the inner peripheral region of the stator core 10. The two fluid passages both extend from the first end 101 to the second end 102. Also in this embodiment, one set of laminations 103 align the second teeth 1032 in the first position thereof in the axial direction Z to form a first stator segment 103A having a first flow passage segment 104A, and the other set of laminations 103 align the second teeth 1032 in the first position thereof in the axial direction Z to form a second stator segment 103B having a second flow passage segment 104B. The first stator segment 103A and the second stator segment 103B are stacked so that the first flow passage segment 104A and the adjacent second flow passage segment 104B are at least partially staggered both in the inner circumference direction and in the axis direction, to form a curvilinear first fluid passage 104 on the surface surrounding the inner peripheral region of the stator core 10. Likewise, the second teeth 1032 in the second position opposite to the first position are aligned in the axial direction Z to form a third flow passage segment 104′A and a fourth flow passage segment 104′B. The third flow passage segment 104′A and the fourth flow passage segment 104′B are at least partially staggered both in the inner circumference direction and in the axis direction, to form a curvilinear second fluid passage 104′ on the surface surrounding the inner peripheral region of the stator core 10. Those skilled in the art can also understand that the first fluid passage 104 formed by the first flow passage segment 104A of the first stator segment 103A and the second flow passage segment 104B of the second stator segment 103B, and the second fluid passage 104′ formed by the third flow passage segment 104′A of the first stator segment 103A, the fourth flow passage segment 104′B of the second stator segment 103B shown in FIG. 2B are only example. Wherein each set of stator segment may be formed by stacking a different number of stator laminations 103, and the fluid passage 104 may be formed by two or more sets of stator segments in the stacked manner as shown in FIG. 2A. And more fluid passages can also be formed in the above stacked manner as required.

It will be understood by those skilled in the art that more spaced fluid passages may be provided. Two or more fluid passages may be evenly spaced. In this embodiment, the above-described fluid passages are generally curvilinear or helical around the inner peripheral surface. It can also be seen that the above-mentioned fluid passage 104 also presents a sawtooth or stepped shape. It can be understood by those skilled in the art that, in another embodiment of the present disclosure, the second teeth 1032 of the plurality of laminations 103 can be aligned with each other in the axial direction Z to form a linear fluid channel. It can be understood that the linear fluid passage is parallel to the axial direction Z, that is, the fluid passage is also parallel to the central axis of the stator core 10.

Those skilled in the art can understand that the number of the second teeth 1032 in the stator laminations 10 can be set according to cooling requirements. And the arrangement of one or more second teeth 1032 is also included in the scope of protection claimed by the disclosure.

By forming the fluid passages 104, 104′ as described above, only one punching core is required when manufacturing the stator laminations 103, that is, the arrangement of the first teeth 1031 and the second teeth 1032 on each stator lamination 103 can be exactly the same. In this way, the purpose of reducing costs and improving production efficiency can be achieved.

During the cooling operation of the stator core 10 of the present embodiment, the cooling fluid may flow into a fluid inlet of the first end 101 of the stator core 10 and flow out from a fluid outlet of the second end 102. It can be understood that the fluid inlet and the fluid outlet can be interchanged depending on the arrangement of other components, i.e. the fluid inlet can be provided on the second end 102 and the fluid outlet can be provided on the first end 101. By allowing the cooling fluid to flow through the first fluid passage 104 and the second fluid passage 104′ on the surface of the inner peripheral region of the stator core 10, rapid cooling of the stator core 10 can be achieved. Thus, the cooling efficiency is improved and the normal operation of the motor is guaranteed.

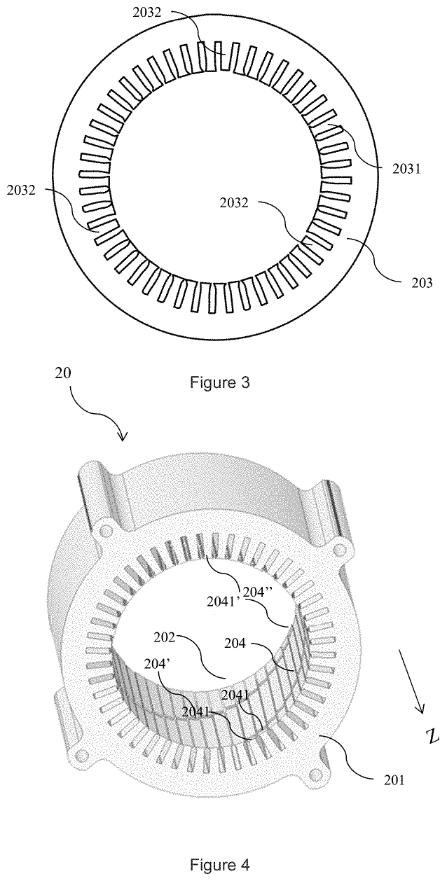

Next, in another embodiment shown in FIGS. 3 and 4, s stator core 10 is also composed of a plurality of stator laminations 103 stacked along an axial direction Z. And thus, a first end 101 and a second end 102 of the stator core 10 are formed, wherein the second end 102 is opposite to the first end 101 in the Z direction.

The stator lamination 203 has a plurality of teeth extending inwardly in a radial direction. The plurality of teeth include first teeth 2031 with a first radial length and second teeth 2032 with a second radial length, wherein the first radial length is larger than the second radial length. The plurality of teeth extend in the radial direction to form a plurality of slots extending from the inner circumference toward the outer circumference of the stator laminations 203. Different from the embodiment shown in FIG. 1, the stator laminations 203 in this embodiment have three second teeth 2032 that are evenly spaced along the inner circumference.

Similar to the embodiment of FIGS. 1 and 2, when a plurality of stator laminations 203 are stacked to form the stator core 20, the stator laminations 203 align three second teeth 1032 at different positions in the axial direction Z to form a first fluid passage 204, a second fluid passage 204′ and a third fluid passage 204″ on the inner peripheral region of the stator core 10. The three fluid passages all extend from the first end 201 to the second end 202. Also in this embodiment, the plurality of laminations align the second teeth 2032 thereof in the axial direction Z to form a stator segment having a first flow passage 2041. The plurality of stator segments are stacked so that the first flow passage 2041 and the adjacent first flow passage 2041 are at least partially staggered both in the inner circumference direction and in the axis direction, to form a curvilinear first fluid passage 204 on the surface surrounding the inner peripheral region of the stator core 10. In the same way, the other two second teeth 2032 in different positions can also form the second flow passage 2041′ and the third flow passage (not shown) respectively, and make the second flow passage 2041′ and the third flow passage to surround the surface of the inner peripheral region of the stator core to form curved second fluid passage 204′ and curved third fluid passage 204″. In the embodiment shown in the figures, since the stator lamination 203 includes three second teeth 2032, when the stator laminations 203 are stacked to form the stator core 20, three fluid passages spaced apart from each other are formed on the surface of the inner peripheral region of the stator core 20.

Those skilled in the art can understand that a plurality of fluid passages spaced apart from each other can be provided by providing more second teeth at different positions on the lamination. The plurality of fluid passages may be spaced apart from each other at different intervals.

During the cooling operation of the stator core 20 of the present embodiment, the cooling fluid may flow into the fluid inlet of the first end 201 of the stator core 20 and flow out from the fluid outlet of the second end 202. Through the first fluid passage 204, the second fluid passage 204′ and the third fluid passage 204″ that uniformly arranged along the inner circumference, a plurality of fluid passages pass through in the axial direction Z in the inner circumference area. Thus, the cooling efficiency is improved and the normal operation of the motor is guaranteed.

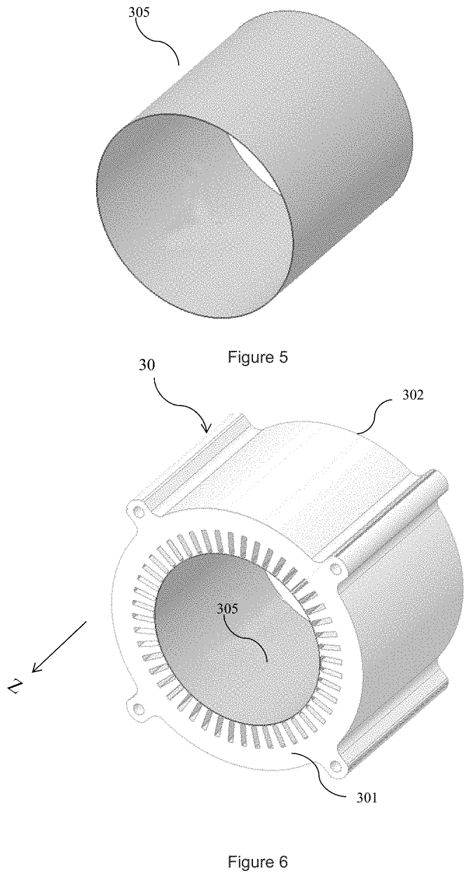

Next, another embodiment of the present disclosure is shown in FIGS. 5 and 6. Different from the above two embodiments, the stator core 30 in this embodiment has an inner wall member 305. The inner wall member 305 is a hollow cylinder. And the inner wall piece 305 is configured to adjoin the inner circumference of the stator core with its outer circumferential surface. In this embodiment, the plurality of slots formed by the plurality of teeth of the stator core 30 are all open slots. The adjoining of the inner wall member 305 and the surface of the inner peripheral region of the stator core 30 closes the openings of the open slots to form a closed fluid passage, for avoiding fluid overflow, and achieving better cooling effect. It can be understood that, the stator core 10 in the embodiment shown in FIGS. 1 and 2 and the stator core 20 shown in FIGS. 3 and 4 can use the inner wall member 305 disclosed in this embodiment to realize the open slot closure of the opening to form a closed fluid passage.

In this embodiment, the inner wall member 305 extends from the first end 301 to the second end 302 in the axial direction Z. And in this embodiment, the thickness of the inner wall member 305 is less than 0.2 mm, which can be made of glass fiber-reinforced high-strength plastics or high-strength steels by injection molding or forging processes. It is understood that other materials and processes suitable for manufacturing the inner wall member 305 are also included in the protection scope claimed by the present disclosure.

A comparative experiment is carried out on a conventional motor, and motor 1 with two fluid passages, and an electric machine 2 with three fluid passages of the present disclosure, and the results are shown in Table 1 below:

TABLE 1
Torque and torque fluctuation comparison table

| | base | Torque |
|---|---|---|
| | torque | fluctuation |
| conventional | 10.16 NM | 0.64 NM |
| electric machine | | |
| electric machine 1 | 10.47 NM | 0.68 NM |
| with two fluid | | |
| passages | | |
| electric machine 2 | 10.03 NM | 0.69 NM |
| with three fluid | | |
| passages | | |

It can be seen from the above experimental results that the arrangement of the above-mentioned fluid passages does not significantly affect the performance of the electric machine except for cooling the inner peripheral region of the stator core.

Where it is technically possible, the technical features listed in relation to different embodiments can be combined with each other to form further embodiment within the scope of the present disclosure.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The term “including” is inclusive and has the same scope as “comprising”.

The above-mentioned embodiments are possible examples of implementations of the present disclosure and are given only for the purpose of enabling those skilled in the art to clearly understand the principles of the disclosure. It should be understood by those skilled in the art that the above discussion to any embodiment is only illustrative, and is not intended to imply that the disclosed scope of the embodiments of the present disclosure (including claims) is limited to these examples; under the overall concept of the disclosure, the technical features in the above embodiments or different embodiments can be combined with each other to produce many other their variants in different aspects of embodiments of the disclosure that is not provided in detailed description for the sake of brevity. Therefore, any omission, modification, equivalent replacement, improvement, etc. made within the spirit and principle of the embodiment of the disclosure shall be included in the scope of protection claimed by the disclosure.

While representative embodiments are described above, it is not intended that these embodiments describe all possible forms of the claimed subject matter. The words used in the specification are words of description rather than limitation, and it is understood that various changes may be made without departing from the spirit and scope of the claimed subject matter. Additionally, the features of various implementing embodiments may be combined to form further embodiments that may not be explicitly illustrated or described.

What is claimed is:

1. A stator core of an electric machine, comprising:
a plurality of laminations stacked in an axial direction to form the stator core, each lamination having an inner circumference and an outer circumference, each lamination having a plurality of teeth extending toward the inner circumference in a radial direction forming a plurality of slots therebetween, the plurality of teeth of each lamination including first teeth having a first radial length and at least one second tooth with a second radial length, wherein the at least one second tooth of each of the plurality of laminations is arranged in the axial direction to form a fluid passage extending between first and second ends of the stator core.

2. The stator core of claim 1 wherein the second radial length is smaller than the first radial length.

3. The stator core of claim 1, wherein at least some of the plurality of slots are closed slots without an opening toward the inner circumference.

4. The stator core of claim 1, wherein at least some of the plurality of slots are open slots with an opening toward the inner circumference, and wherein the stator core has an inner wall member that is a hollow cylinder and is configured to adjoin the inner circumference of the stator core to close the opening.

5. The stator core of claim 1 wherein the second teeth of the plurality of laminations are aligned along the axial direction to form the fluid passage parallel to a central axis of the stator core.

6. The stator core of claim 1, wherein the second teeth of the plurality of laminations are at least partially staggered along the axial direction to form the fluid passage at least partially surrounding an inner peripheral surface of the stator core.

7. The stator core of claim 1, wherein the plurality of laminations comprises a first set of laminations and a second set of laminations, the first set of laminations aligning the second teeth thereof along the axial direction to form a first stator segment having a first flow passage segment, and the second set of laminations aligning the second teeth thereof along the axial direction to form a second stator segment having a second flow passage segment, wherein the first and second stator segments are stacked so that the first and second flow passage segments are fluidly connected and at least partially staggered to form the fluid passage around an inner peripheral surface of the stator core.

8. The stator core of claim 1, wherein the plurality of teeth of each lamination include at least a second tooth in a first position and a second tooth in a second position, wherein a plurality of second teeth in the first position are at least partially aligned along the axial direction to form a first fluid passage, and a plurality of second teeth in the second position are at least partially aligned along the axial direction to form a second fluid passage, wherein the second tooth in the first position is different from the second tooth in the second position.

9. The stator core of claim 8, wherein the plurality of laminations align the second teeth in the first position thereof along the axial direction to form a stator segment having a first flow passage, and the stator segment at least includes a first stator segment and a second stator segment, and the first and second stator segments are stacked so that the first flow passages are fluid connected and spirally surround an inner peripheral surface of the stator core to form the first fluid passage; and
the plurality of laminations align the second teeth in the second position thereof along the axial direction to form a stator segment having a second flow passage, and the stator segment at least includes a first stator segment and a second stator segment, and the first and second stator segments are stacked so that the second flow passages are fluid connected and spirally surround the inner peripheral surface of the stator core to form the second fluid passage.

10. The stator core of claim 1, wherein the first and the second fluid passages are parallel to a central axis of the stator core.

11. An electric machine comprising:
a rotor; and
a stator surrounding the rotor with an air gap therebetween, wherein the stator includes a stator core having an inner circumference and an outer circumference formed by stacking a plurality of laminations in an axial direction, wherein each lamination has a plurality of teeth extending toward the inner circumference in a radial direction forming a plurality of slots therebetween, and wherein the plurality of teeth of each lamination include first teeth with a first radial length and at least one second tooth with a second radial length, wherein the second teeth of the plurality of laminations are arranged in the axial direction to form a fluid passage extending between first and second ends of the stator core.

12. The electric machine of claim 11 wherein the second radial length is less than the first radial length.

13. The electric machine of claim 11, wherein at least some of the plurality of slots are closed slots without an opening toward the inner circumference.

14. The electric machine of claim 11, wherein at least some of the plurality of slots are open slots with an opening toward the inner circumference, and wherein the stator core has an inner wall member forming a hollow cylinder configured to adjoin the inner circumference of the stator core to close the opening.

15. The electric machine of claim 11, wherein the plurality of laminations comprises a first set of laminations and a second set of laminations, the first set of laminations align the second teeth thereof along the axial direction to form a first stator segment having a first flow passage segment, and the second set of laminations align the second teeth thereof along the axial direction to form a second stator segment having a second flow passage segment, wherein the first and second stator segments are stacked so that the first and second flow passage segments are fluidly connected and at least partially staggered to form the fluid passage around an inner peripheral surface of the stator core,

16. The electric machine of claim 11, wherein the plurality of teeth of each lamination include at least a second tooth in a first position and a second tooth in a second position, wherein the plurality of second teeth in the first position are at least partially aligned along the axial direction to form a first fluid passage, and a plurality of second teeth in the second position are at least partially aligned along the axial direction to form a second fluid passage, wherein the second tooth in the first position is different from the second tooth in the second position.

17. The electric machine of claim 16, wherein the first and the second fluid passages are parallel to a central axis of the stator core.

18. The electric machine of claim 16, wherein the plurality of laminations align the second teeth in the first position thereof along the axial direction to form a stator segment having a first flow passage, wherein the stator segment at least includes a first stator segment and a second stator segment, and the first and second stator segments are stacked so that the first flow passages are fluidly connected and spirally surround an inner peripheral surface of the stator core to form the first fluid passage, and the plurality of laminations align the second teeth in the second position thereof along the axial direction to form a stator segment having a second flow passage, the stator segment at least includes a first stator segment and a second stator segment, and the first and second stator segments are stacked so that the second flow passages are fluid connected and spirally surround the inner peripheral surface of the stator core to form the first fluid passage.

19. A cooling method for a stator core, comprising:
stacking a plurality of laminations in an axial direction to form the stator core having an inner circumference and an outer circumference, wherein each lamination has a plurality of teeth extending toward the inner circumference in a radial direction forming a plurality of slots therebetween, wherein the plurality of teeth of each lamination include first teeth with a first radial length and at least one second tooth with a second radial length, and the second teeth of the plurality of laminations are arranged in the axial direction to form a fluid passage between first and second ends of the stator core; and
flowing a cooling fluid through the fluid passage in an axial direction between the first and second ends of the stator core.

20. The method of claim 19, wherein the second teeth of the plurality of laminations are at least partially staggered along the axial direction to form the fluid passage at least partially spirally surrounding an inner peripheral surface of the stator core.
